(19) United States
(12) Patent Application Publication
(10) Pub. No.: US 2006/0243793 A1
(43) Pub. Date: Nov. 2, 2006

(54) Value unit

(76) Inventor: Neil E. Siewert, Edmonton (CA)

Correspondence Address: Arthur W. Fisher;Patent Dominion LP, Suite 200, 555 Republic Drive, Plano, TX, 75074, US

(21) Appl. No.: 11/409,867

(22) Filed: Apr. 24, 2006

Related U.S. Application Data
(60) Provisional application No. 60/675,079, filed on Apr. 27, 2005.

(51) Int. Cl. G06K 5/00

(52) U.S. Cl. 235/380

(57) ABSTRACT

A value unit for conveying or transferring value, currency, information, data, images, video and/or audio and comprising a thin medium for attachment to mail, packages, documents or other items to be transferred or exchanged or for use as a financial or informational card, check or other instrument, a readable/writeable memory device disposed in the medium for receiving, storing or transferring data, information and/or images and one or more displays, disposed in the medium, for visual depiction of information or images from data, information or images stored in the memory. A number of embodiments are described with additional, optional devices including an interface device comprised of a plurality of raised areas for coupling to corresponding contacts in the mating connector, the areas comprised of a material for conducting optical or electrical energy or signals and surrounded by insulating material that defines the areas and prevents the transfer of energy or signals between the areas and a sensing system for detecting if a container has been opened or tampered with.

### CROSS REFERENCE TO RELATED APPLICATIONS

The present application is a completed application replacing U.S. Provisional Patent Application Ser. No. 60/675,079, filed Apr. 27, 2005, entitled “Secondary Memory and Information Presentation device and Apparatus”. The priority date of Application 60/675,079 is claimed.

### BACKGROUND OF THE INVENTION

### Description of the Related Art

As the pace of technology continues, new, economically feasible applications arise. Advances in display technology such as miniature, organic light emitting diodes, miniaturized processors and memory units are among a few of these developments.

Postage has, since inception, been confined to paper with an image printed thereon and affixed to a letter or parcel which is being mailed. Packing labels and shipping documents have been largely limited in the same way.

Paper checks are still the primary form of monetary conveyance. Credit and debit cards using magnetic strips have been in use for years, but they are severely restricted in what they can do.

Electronic tracking devices have been used but these are large and bulky and relatively expensive. Bar code scanning for inventory tracking and electronic check-out is available, but that is limited in that it requires a manual scanning in close proximity of the scanning equipment.

Advertising material and documents have been limited to paper with expensive printing of text and images and it is not re-useable.

Security devices which test for the presence of certain chemical and biological substances are in use but they are limited by the selective location of expensive equipment to check the letters, packages, etc.

Thus, there is a need in the art for a method and apparatus for a cost-efficient, programmable value unit which can be used and re-used/re-programmed with images, data and information for postage, packing lists, shipping documents, tracking, advertising, monetary transfer, security, and a variety of other uses. There is also a need in the art for a cost-effective, diminutive interface device for coupling the electronics within the value unit to control, programming and/or information receiving and sending equipment.

### SUMMARY OF THE INVENTION

A method and apparatus for a value unit for conveying or transferring value, currency, information, data, images, video and/or audio and comprising a thin medium for embedding in, attachment to or stand-alone use as mail, stamps, packing slips, packages, containers, documents, garments, communication devices, merchandise, tags, labels, tickets, trackers, monitors, advertisements, financial or informational cards, checks and/or other items to be transferred, exchanged, monitored, and/or tracked; one or more readable/writeable memory device disposed in the medium for receiving, storing or transferring data, information and/or images; and one or more displays, disposed in the medium, for visual depiction of information or images from data, information or images stored in the memory.

The method and apparatus as described above further comprising one or more interface devices disposed on a surface of the medium for interfacing with external devices and receiving and/or transmitting value, currency, data, information, video and/or audio between the memories and such external devices.

The method and apparatus as described above wherein the display is comprised of organic light emitters.

The method and apparatus as described above further comprising one or more processors disposed in the medium and coupled to the memories for processing information, data and images.

The method and apparatus as described above further comprising one or more transmitters and/or receivers disposed in or on the medium and coupled to the processors for transmitting or receiving, respectively value, currency, data, information, images, video and/or audio to or from a receiving device or transmitting device, respectively.

The method and apparatus as described above further comprising one or more cameras, microphones and/or speakers disposed in or on the medium and coupled to the processor for capturing and/or transmitting video and/or audio.

The method and apparatus as described above further comprising a networking device disposed in or on the medium and coupled to the processor for connecting the value unit to an information network.

The method and apparatus as described above further comprising one or more sensors disposed in or on the medium and coupled to the processor for detecting certain chemical or biological materials and/or temperature, pressure, humidity or other atmospheric conditions and providing an indication of such detection.

The method and apparatus as described above further comprising security means for preventing the unauthorized receipt or transmission of value, currency, data, information, images, video and/or audio from or to the value unit.

The method and apparatus as described further comprising a power source disposed in the medium for powering the value unit.

The method and apparatus as described above wherein the power source is a rechargeable miniature battery or one or more solar or light powered cells.

The method and apparatus as described above further comprising a control system, compatible with the conveyance units, for programming or re-programming the conveyance units and/or for testing the conveyance units.

The method and apparatus as described above wherein the medium is a document including, but not limited to, a postage stamp, label, packing slip, financial or information card, check and/or advertisement.

A method and apparatus for an interface device embedded in or disposed on a thin medium, the medium for embedding in, attachment to or stand-alone use as mail, stamps, packing slips, packages, containers, documents, garments, communication devices, merchandise, tags, labels, tickets, trackers, monitors, advertisements, financial or informational cards, checks and/or other items to be transferred, exchanged, monitored, and/or tracked, the interface device for receiving from and/or transmitting to a mating connector, optical or electrical energy or signals of power, data, information, images, currency, video and/or audio, the interface device comprising a plurality of raised areas for coupling to corresponding contacts in the mating connector, the areas comprised of a material for conducting the optical or electrical energy or signal; and means surrounding each such raised area for defining the areas and/or insulating the transfer of energy between the areas.

The method and apparatus as described above further comprising connection means for aligning the areas with the corresponding contacts of the mating connector and/or securing the interface device to the mating connector.

The method and apparatus as described above further comprising a coin-shaped medium on which or in which the interface device is disposed; and a readable/writeable memory embedded in the coin-shaped medium and coupled to the interface device, the memory for storing and sending or receiving data such as, but not limited to, currency, information, images, video and/or audio to and from the interface device.

A method and apparatus for a system embedded in or attached to an envelope, package or other container for detecting whether such envelope, package or container has been opened or tampered with comprising a sensing system disposed in or on the envelope, package, or other container which detects an opening or tampering.

The system as set forth in claim 19 wherein the sensing system is comprised of a thin wire grid or mesh having an electrical current passing there through and wherein the current flow is interrupted when the envelope, package or container is opened or tampered with and having a value unit embedded in or attached to the envelope, package or container, such value unit further comprising sensing circuitry coupled to the sensing system and responsive to the detection of and opening or tampering by the sensing system; and one or more displays coupled to the sensing circuitry for providing a notification that the envelope, package or container has been opened or tampered with.

### BRIEF DESCRIPTION OF THE DRAWINGS

FIG. 1 is a top view in a schematic diagram form of a value unit with a display and readable/writeable memory embedded therein and an interface device disposed on the surface there of.

FIG. 2 is a top view in a schematic diagram form of a value unit with a display and readable/writeable memory embedded therein; an interface device disposed on the surface there of, a plurality of optional devices embedded therein including a processor, power source, network adaptor, camera, speaker, transmitter, receiver, and sensors and coupled to external control and programming devices.

FIG. 3 is a top, cross-sectional view of an interface device with raised areas for electrical or optical communication with an external device and holes for aligning with and securing to the external device.

FIG. 4 depicts a container having a sensing system and value unit for detecting if the container has been opened or tampered with.

### DETAILED DESCRIPTION

Whilst the making and using of various embodiments of the present invention are discussed in detail below, it should be appreciated that the present invention provides many applicable inventive concepts, which can be embodied in a wide variety of specific contexts. The specific embodiments discussed herein are merely illustrative of specific ways to make and use the invention and do not limit the scope of the invention.

It should be understood that the principles and applications disclosed herein can be applied in a wide range of applications for image display, transferring or conveying data or information, postage and mail systems, currency or monetary transfer systems, advertising, shipping, tracking and security as examples. Moreover, the interface device can be used in any application for the transfer of electrical or optical energy in the form of data, information, power, images, currency, video and audio.

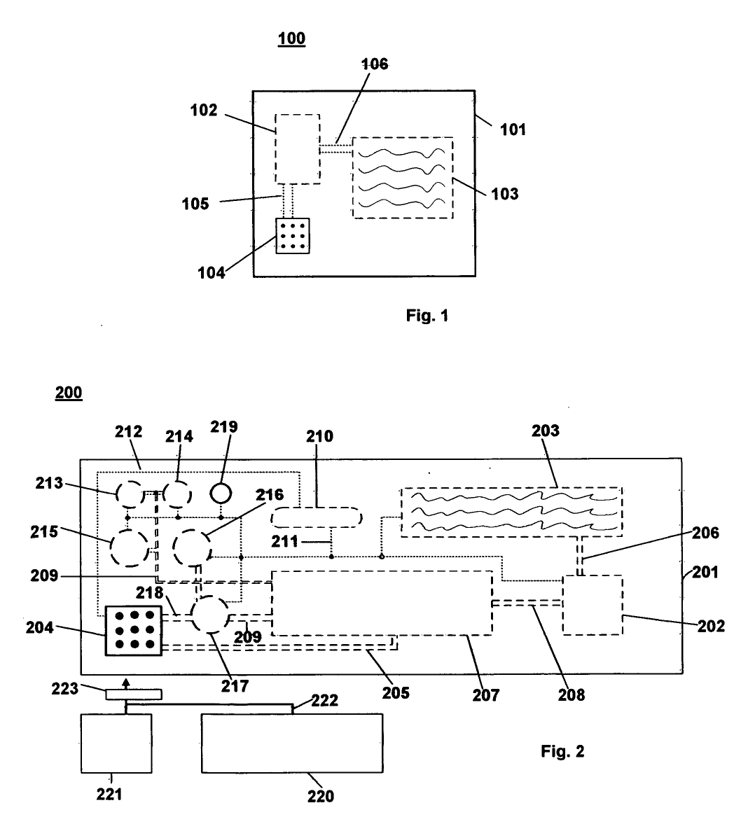

Referring now to FIG. 1, a top view, in schematic diagram form, of a value unit 100 is depicted having a medium 101 with a display 103 and readable/writeable memory 102 embedded therein and an optional, interface device 104 disposed on the surface there of. A power source (shown in FIG. 2 as 210) may also be embedded in the medium 101.

The medium 101 may be of any size suitable to the specific application and preferably comprised of a thin piece of plastic, paper, or any suitable material having insulating characteristics. The display device, embedded in the medium 101, may be comprised of any one of a plurality types of materials such as, but not limited to, plasma, liquid crystal display (LCDs), light emitting diodes (LEDs) and other light emitting materials, and organic light emitters. Organic light emitters are particularly useful for Value Unit 100 as they can be made from extremely thin layers of semi-conductors in very thin substrates of plastic, metal or other materials. The substrates can then be embedded in very thin mediums. The resulting display can be very small area for use within a value unit 100 such as a postage stamp or much larger area for value units 100 requiring a larger display. They are cost-effective and consume very little power. There are two types of these of these organic light emitters including a small molecule type commonly referred to as OLEDs and a large molecule type commonly referred to as polymer LEDs or PLEDs.

The display is located at or near the surface of the medium 101 or viewable through the surface of the medium 101 if the medium 101 is comprised of a translucent material, for example. The display 103 is coupled to the memory 102 via connection 106 and, in response to signals from the memory 102, emits a pre-programmed image and/or other data continuously or periodically in response to the program in the memory 102 or other activating methods. Depending on the materials used for the display 103, the display 103 may also be coupled to the power source. If the value unit 100 is used as a postage stamp, for example, the image displayed on the display 103 may be the particular art work chosen for the postage amount and/or the postage amount itself. If the value unit 100 is to be used as a label, for example, the image displayed on display 103 may include any combination of the following: the manufacturer's logo, brand name, price, materials, instructions, and any other data or images so desired.

The memory 102 is embedded within the medium 101 and connected to the display 103 and also connected to the power source 210 and the interface device 104, if included via connection 105. The memory contains the images, data and other information to be displayed on the display 103. The memory will also contain any other programming information for the displaying of images and data on the display 103.

The memory may be pre-programmed with this information when the value unit is meant to be used permanently or for its lifetime, for one specific use and then to be disposed of and not re-used. For example, if the value unit is to be used as a postage stamp or a label and not re-used, the memory 102 would be pre-programmed when the value unit 100 is made and disposed of when the use is finished. No further need for re-programming or for extracting information or data would be required. In such cases, the interface device 104 and connection 105 would not be required. If the application for the value unit 100 is as a shipping document, a currency transfer device, an advertisement, a tracking or inventory device, or a security device, then it will most likely be desirable to make the value unit re-programmable and re-usable. In such cases, the interface device 104 and connection 105 would likely be included.

Referring to FIG. 2, a top view, in schematic diagram form, of a value unit 200 is depicted including a medium 201 with a display 203 and readable/writeable memory 202 embedded therein, an interface device 204 disposed on the surface there of and a plurality of optional devices embedded therein including a processor 207, power source 210, network adaptor 217, camera 219, speaker/microphone 216, transmitter 213, receiver 214, and sensor(s) 215. Interface device 204 can interface with a mating connector 223 for coupling to external control and programming devices such as reader/activator/port connector 221 and programmer/diagnostics unit 220. It will be appreciated that any combination of the optional devices may be utilized depending the application for the value unit 200 and the features desired.

Value unit 200 also includes a plurality of connections or buses for transmitting electrical or optical signals between the various components disposed in or on the value unit 200. The exact nature of the buses and connectors would depend on the application and would be obvious to one skilled in the art of circuit lay-outs. Bus 205 connects the display 203 to the memory 202. Power bus 211 connects the power source 210 to all components requiring power. Processor bus 208 connects the processor 207 to the memory 202 and processor bus 209 connects the processor 207 to the other optional components. The processor I/O bus 205 connects the processor 207 to the interface device 204 for direct connection of the processor to the external control and programming devices 221 and 220. The network adaptor 110 bus 218 connects the network adaptor 216 to the interface device 204 for fixed-line connection to a network such as, for example, a local (LAN), a wide area (WAN), the internet, etc. The processor I/O and network adaptor I/O buses may be electrical or optical conductors or a combination there of. Optical to electrical transceiver/converters (not shown) would be used to convert the optical signals to electrical and vice versa if optical connections/buses are used. Power I/O bus 212 connects the power device 210 to the interface device 204 for connection to the external control and programming devices 221 and 220.

Power source 210 may be any suitable, small source of electrical power for the value unit 200. For example, the power source 210 may be comprised of photo-voltaic cells for converting light received by the cells into electrical energy to power the value unit and provide a renewable source of power for the value unit 200. A miniaturized, preferably rechargeable, battery may also be used as the power source 210. Power I/O bus 212 is utilized, for example, to permit re-charging of power source 210, if power source 210 is a re-chargeable battery, for an external source of power for the value unit 200 and/or to perform diagnostics on the power source 210.

The memory 202 and display 203 function in much the same manner as described for memory 102 and display 103, respectively, described for FIG. 1. The memory 202 will contain the desired data to be stored for the value unit 200 and to be displayed on the display 203. Thus, for example, if value unit 200 was to be used for a check or credit/debit card or other form of currency conveyance, then memory would store the data to be displayed at the appropriate time including, but not limited to, the amount to be transferred, the payee and/or payor, a note, an image, if desired, and any other useful information. It could also store and display the state of the transaction such as, for example, whether or not the amount has been transferred or not. For an advertising use of the value unit, a video could be displayed or alternating texts and/or images.

The processor 207 is used for a variety of purposes depending on the application of the value unit 200 and the features desired. The processor will read/write and update the memory 102. It will also process data and perform command and control functions over the processor buses 208 and 209 for the other optional devices in the value unit 200. For re-useable applications of the value unit 200, it will communicate directly with the external control and programming devices, 221 and 220 transmitting and receiving data and information including, but not limited to, images, currency, video and audio.

The memory 202 and/or processor 207 may also be programmed with security apparatus such as, for example, password protection, to prevent unauthorized use of or access to the information, data or currency in the value unit 200. Additionally, they can be programmed to protect the identity of the sender and/or receiver, the payor or payee, the address or any other information for which it is desired that only authorized individuals have access to.

For many applications such as, for example, remote tracking of inventory and/or shipping location, scanning, and wireless network/internet connection the use of an optional transmitter 213 and receiver 214 is desirable. It will be appreciated that a single transceiver may be used in lieu of or even in addition to the transmitter and receiver.

The optional camera 219 and microphone/speaker 216 can be used in a variety of applications for the value unit 200 and/or for a variety of desired features. For example, the camera 219 could be used for taking, recording and/or transmitting an image of the individual owing or using the value unit 200 or surrounding conditions of the value unit 200 at any given time. The microphone/speaker 216 can be used, for example, to receive and/or record audio or verbal information or to audibly convey information, greetings, alarms and/or security alerts or as an audible aid for location identification. It will be understood and appreciated that the microphone/speaker 216 may be a combination speaker/microphone, or a stand-alone microphone or a speaker or both.

The optional sensor(s) 215 can be used in a variety of applications for the value unit 200 and/or a variety of desired features. For example, life or health threatening chemicals or biological substances can be detected in boxes or packages or envelopes for shipping and/or mail system uses. If detected, an alert or alarm can be instantly transmitted to authorities along with tracking/location information. An immediate alarm or indication can also be given on the display 203 and/or on the microphone/speaker 216. In a shipping system for perishables or artifacts or any materials sensitive to environment, the temperature, humidity, pressure, and/or a variety of environmental conditions can be sensed, recorded and subsequently or immediately transmitted in response to routine tracking or monitoring activities. In inventory or stocking applications, for example, shelving or containers which are configured to monitor inventory or merchandise with value units 200 embedded in or attached thereto, can provide indications immediately of what stock is moving, where re-stocking is required, aging of stock and a host of other data activities. It could even re-price, re-program inventory as desired.

It will be appreciated that the present invention encompasses a variety of combinations of devices for a variety of applications for finance, postage, shipping, inventory, check-out, tracking, communications, ticketing, monitoring, security, inventory, etc. and that the present invention is not limited to the combinations or applications presented here in.

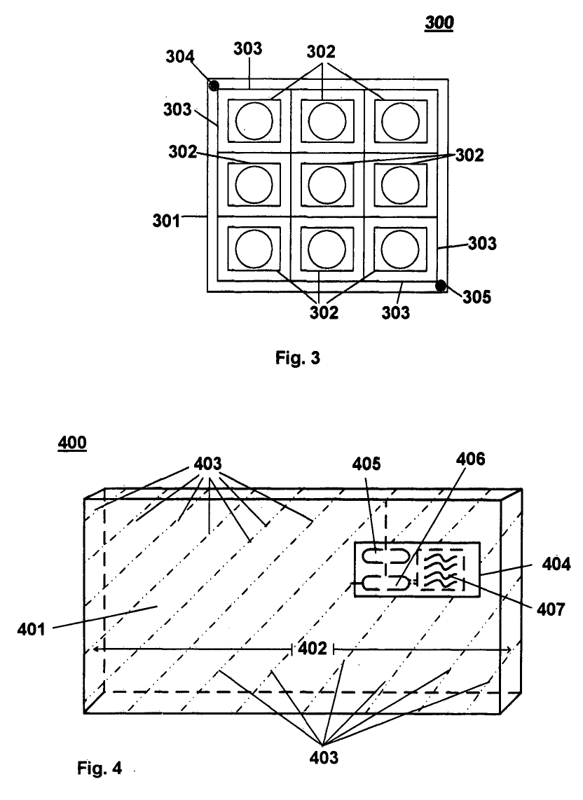

Referring to FIG. 3, a top, cross-sectional view of an interface device 300 is depicted with raised areas for electrical or optical communication with an external device and holes 304 and 305 for aligning with and securing to the external device. The interface device 300 is comprised of a housing 301 embedded in a medium or in a housing with a surface extending from or level with the surface of the medium or housing.

The housing 301 is divided into a plurality of electrically and/or optically insulated cells 302 electrically or optically connected to circuitry within the housing or medium. Each cell 302 has a raised, flexible surface which couples to a contact of a mating connector (not shown) and which transmits or receives electrical or optical signals. The electrical or optical signals transmitted or received can be in the form of dedicated signal lines or can be pulsed in binary format across some or all of the raised surfaces of the cells. In FIG. 3, 9 such cells are depicted. If six of the cells were dedicated to binary pulses of electrical or optical energy, then 6 bit words of data or information can be pulsed to and from the interface device 300 at very high rates of speed. In this example, 3 of the cells, for example, would be dedicated to a power I/O bus such as that power I/O bus 212 in FIG. 2: two cells for power transfer and one cell for diagnostics.

It will be appreciated and understood that any number of cells may be used in the present invention depending the requirements of the particular application. Furthermore, dedicated electrical and/or optical lines may be used in lieu of or in addition to pulsed transmissions.

In FIG. 3, the cells are separated by a series of grooves 303 which may be used to insulate one cell from the others. The grooves may also be utilized to align the interface device 300 with a mating connector. For example, if the mating connector had a grid of outwardly extending walls corresponding to the grid of grooves 303, then when connected together the interface device 300 and the mating connector would align securely because of the walls-in-grooves connection.

Additionally, the interface device 300 is shown with alignment/fastening holes 304 which would accept pins, for example, from the mating connector when connected together. The interface device 300 could then properly be aligned and secured with the mating connector for transmission/reception of electrical and/or optical signals. It will be appreciated and understood that the present invention encompasses any number of methods and means to align and/or secure the interface device with the mating connector.

Referring now to FIG. 4, a container 401 is depicted with a sensing system 400. The sensing system 400 is comprised of wire grid 402 of minute, electrical conductors 403. The electrical conductors 403 are all connected in one grid or series circuit. The container also has a value unit 404 embedded in or attached to it. The value unit 404 has a power source 405, sensing circuitry 406 and a display 407.

Once the container is closed or sealed and ready for storage, shipment, transfer, etc. and the value unit 404 activated, the power source 405 provides a small amount of current through the grid 402. If the container is opened or tampered with, the current flow through the grid 402 is interrupted. The interruption is sensed by the sensing circuitry and an appropriate message is sent to the display indicating an opening or tampering. It will be appreciated that the value unit 404 may have additional components for storing the information, date and time, transmitting this information, etc. It will be further appreciated that any number of techniques for sensing an opening or tampering of the container and are all within the scope of the invention. Moreover, the invention may be used with any container including, but not limited to envelopes, cartons, packages, cargo containers, etc.

Thus, the present invention has been described herein with reference to particular embodiments for particular applications. Those having ordinary skill in the art and access to the present teachings will recognize additional modifications, applications, and embodiments within the scope thereof.

It is, therefore, intended by the appended claims to cover any and all such applications, modifications, and embodiments within the scope of the present invention.

What is claimed is:

1. A value unit for conveying or transferring value, currency, information, data, images, video and/or audio and comprising:
a thin medium for embedding in, attachment to or stand-alone use as mail, stamps, packing slips, packages, containers, documents, garments, communication devices, merchandise, tags, labels, tickets, trackers, monitors, advertisements, financial or informational cards, checks and/or other items to be transferred, exchanged, monitored, and/or tracked;
one or more readable/writeable memory device disposed in the medium for receiving, storing or transferring data, information and/or images; and
one or more displays, disposed in the medium, for visual depiction of information or images from data, information or images stored in the memory.

2. The value unit of claim 1 further comprising:
one or more interface devices disposed on a surface of the medium for interfacing with external devices and receiving and/or transmitting value, currency, data, information, video and/or audio between the memories and such external devices.

3. The value unit as set forth in claim 2 wherein the display is comprised of organic light emitters.

4. The value unit as set forth in claim 1 further comprising:
one or more processors disposed in the medium and coupled to the memories for processing information, data and images.

5. The value unit as set forth in claim 4 further comprising:
one or more transmitters and/or receivers disposed in or on the medium and coupled to the processors for transmitting or receiving, respectively value, currency, data, information, images, video and/or audio to or from a receiving device or transmitting device, respectively.

6. The value unit as set forth in claim 4 further comprising:
one or more cameras, microphones and/or speakers disposed in or on the medium and coupled to the processor for capturing and/or transmitting video and/or audio.

7. The value unit as set forth in claim 4 further comprising:
a networking device disposed in or on the medium and coupled to the processor for connecting the value unit to an information network.

8. The value unit as set forth in claim 3 further comprising:
one or more sensors disposed in or on the medium and coupled to the processor for detecting certain chemical or biological materials and/or temperature, pressure, humidity or other atmospheric conditions and providing an indication of such detection.

9. The value unit as set forth in claim 1 further comprising;
security means for preventing the unauthorized receipt or transmission of value, currency, data, information, images, video and/or audio from or to the value unit.

10. The value unit as set forth in claim 1 further comprising:
a power source disposed in the medium for powering the value unit.

11. The value unit as set forth in claim 10 wherein the power source is a rechargeable miniature battery or one or more solar or light powered cells.

12. The value unit as set forth in claim 1 further comprising:
a control system, compatible with the conveyance units, for programming or re-programming the conveyance units and/or for testing the conveyance units.

13. The value unit as set forth in claim 1 wherein the medium is a document including, but not limited to, a postage stamp, label, packing slip, financial or information card, check and/or advertisement.

14. A shipping or mail system using one or more value units as set forth in claim 1.

15. A currency or value exchange system using one or more value units as set forth in claim 1.

16. An interface device embedded in or disposed on a thin medium, the medium for embedding in, attachment to or stand-alone use as mail, stamps, packing slips, packages, containers, documents, garments, communication devices, merchandise, tags, labels, tickets, trackers, monitors, advertisements, financial or informational cards, checks and/or other items to be transferred, exchanged, monitored, and/or tracked, the interface device for receiving from and/or transmitting to a mating connector, optical or electrical energy or signals of power, data, information, images, currency, video and/or audio, the interface device comprising:
a plurality of raised areas for coupling to corresponding contacts in the mating connector, the areas comprised of a material for conducting the optical or electrical energy; and
means surrounding each such raised area for defining the areas and/or insulating the transfer of energy between the areas.

17. The interface device as set forth in claim 16 further comprising:
connection means for aligning the areas with the corresponding contacts of the mating connector and/or securing the interface device to the mating connector.

18. The interface device as set forth in claim 16 further comprising:
a coin-shaped medium on or in which the interface device is disposed; and
a readable/writeable memory embedded in the coin-shaped medium and coupled to the interface device, the memory for storing and sending or receiving data such as, but not limited to, currency, information, images, video and/or audio to and from the interface device.

19. A system embedded in or attached to an envelope, package, housing, or other container for detecting whether such envelope, package or container has been opened or tampered with comprising;
a sensing system disposed in or on the envelope, package, or other container which detects an opening or tampering.

20. The system as set forth in claim 19 wherein the sensing system is comprised of a thin wire grid or mesh having an electrical current passing there through and wherein the current flow is interrupted when the envelope, package or container is opened or tampered with and having value unit embedded in or attached to the envelope, package or container, such value unit further comprising:
sensing circuitry coupled to the sensing system and responsive to the detection of and opening or tampering by the sensing system, and
one or more displays coupled to the sensing circuitry for providing a notification that the envelope, package or container has been opened or tampered with.
